(19) United States
(12) Patent Application Publication
(10) Pub. No.: US 2021/0319503 A1
(43) Pub. Date: Oct. 14, 2021

(54) BIDDING METHOD AND SYSTEM

(71) Applicant: Naif Abdullah Al Humidan, Qarwa (SA)

(72) Inventor: Naif Abdullah Al Humidan, Qarwa (SA)

(21) Appl. No.: 17/271,916

(22) PCT Filed: Sep. 6, 2019
(86) PCT No.: PCT/US2019/050070

§ 371 Date: Feb. 26, 2021

Related U.S. Application Data
(60) Provisional application No. 62/766,744, filed on Nov. 1, 2018.
(60) Provisional application No. 62/765,666, filed on Sep. 6, 2018.

(51) Int. Cl. G06Q 30/08; G06Q 20/26; G06Q 20/40

(52) U.S. Cl. CPC G06Q 30/08; G06Q 20/407; G06Q 20/26

(57) ABSTRACT

A bidding process for selling or renting an item or service to a highest bidder is described. The process includes receiving from an owner a listing for an item or service and displaying the listing to potential bidders. The process also includes setting a price by the owner to the item for which a potential bidder can win the item pending an auction and receiving an acceptance indication from a bidder to the set price. Further, the process includes conducting an auction using the accepted set price as an opening bid among the potential bidders, declaring a highest bidder as winner of the auction, and instructing the owner and the winning bidder to finalize transaction and complete the deal.

### CROSS-REFERENCE TO RELATED APPLICATIONS

This application claims priority to U.S. Provisional Application No. 62/765,666, entitled “IMPROVED BIDDING PROCESS”, filed on Sep. 6, 2018 by inventor Naif Abdullah Al Humidan. This application also claims priority to U.S. Provisional Application No. 62/766,744, entitled “IMPROVED BIDDING PROCESS”, filed on Nov. 1, 2018 by inventor Naif Abdullah Al Humidan. This application also claims priority to International Application No. PCT/US2019/050070, entitled “BIDDING METHOD AND SYSTEM”, filed on Sep. 6, 2019 by inventor Naif Abdullah Al Humidan. All of these applications are hereby incorporated by reference in their entirety.

### BACKGROUND

An auction is a process of buying and selling goods or services by offering them up for bid, taking bids, and then selling the item to the highest bidder. The open ascending price auction may be the most common form of auction in use today. Participants bid openly against one another, with each subsequent bid required to be higher than the previous bid. Auctions are most associated with the sale of antiques, rare collectibles, paintings, and expensive wines. Auctions are also used for commodities, livestock, radio spectrum, real estate, and used cars. An auction may refer to any mechanism or set of trading rules for exchange.

A reverse auction is a type of auction in which the roles of the buyer and the seller are reversed, with the primary objective to drive purchase prices downward. While ordinary auctions provide suppliers the opportunity to find the best price among interested buyers, reverse auctions give buyers a chance to find the lowest-price supplier. During a reverse auction, suppliers may submit multiple offers, usually as a response to competing suppliers' offers, bidding down the price of a good or service to the lowest price they are willing to receive.

These auctions, although well-known and long used, have various shortcomings often used by both buyers and sellers to game or exploit the auction system. Accordingly, there is a need for an improved bidding process which overcomes the shortcomings of traditional auction processes and provides a better experience for buyers and sellers.

### SUMMARY

An exemplary embodiment relates to a bidding process for selling or renting an item or service to a highest bidder. The process includes receiving from an owner a listing for an item or service and displaying the listing to potential bidders. The process also includes setting a price by the owner to the item for which a potential bidder can win the item pending an auction and for which prices are inversely proportional to auction duration and receiving an acceptance indication from a bidder to the set price. Further, the process includes conducting an auction using the accepted set price as an opening bid among the potential bidders, declaring a highest bidder as winner of the auction, and instructing the owner and the winning bidder to finalize transaction and complete the deal.

Another exemplary embodiment relates a bidding process for buying or renting an item or service to a lowest bidder. The process includes receiving from an owner a listing for an item and displaying the listing to potential bidders. The process also includes setting a price by the owner to the item for which a potential bidder can win the item pending an auction and for which prices are directly proportional to auction duration and receiving an acceptance indication from a bidder to the set price. Further, the process includes conducting an auction using the accepted set price as an opening bid among the potential bidders and declaring a lowest bidder as winner of the auction. Yet further still, the process includes instructing the owner and the winning bidder to finalize transaction and complete the deal.

Yet another exemplary embodiment relates to a computer-readable medium containing instructions which, when executed by a computing device connected to other computing devices on a telecommunication network, implement a bidding process for selling or renting an item or service to a highest bidder. The process includes receiving from an owner a listing for an item or service and displaying the listing to potential bidders. The process also includes setting a price by the owner to the item for which a potential bidder can win the item pending an auction and for which prices are inversely proportional to auction duration and receiving an acceptance indication from a bidder to the set price. Further, the process includes conducting an auction using the accepted set price as an opening bid among the potential bidders, declaring a highest bidder as winner of the auction, and instructing the owner and the winning bidder to finalize transaction and complete the deal.

Yet still another exemplary embodiment relates to a computer-readable medium containing instructions which, when executed by a computing device connected to other computing devices on a telecommunication network, implement an improved bidding process. The process includes receiving from an owner a listing for an item and displaying the listing to potential bidders. The process also includes setting a price by the owner to the item for which a potential bidder can win the item pending an auction and for which prices are directly proportional to auction duration and receiving an acceptance indication from a bidder to the set price. Further, the process includes conducting an auction using the accepted set price as an opening bid among the potential bidders and declaring a lowest bidder as winner of the auction. Yet further still, the process includes instructing the owner and the winning bidder to finalize transaction and complete the deal.

In addition to the foregoing, other system aspects are described in the claims, drawings, and text forming a part of the disclosure set forth herein. The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the disclosures set forth herein.

### BRIEF DESCRIPTION OF THE DRAWINGS

FIG. 1 is an exemplary embodiment of a characteristic system that may be used to implement the invention.

FIG. 2 is an exemplary process diagram of the inventive auction process

The use of the same symbols in different drawings typically indicates similar or identical items unless context dictates otherwise.

### DETAILED DESCRIPTION

The disclosed exemplary embodiments provide an improved bidding process for local traders such as those who list their real estate properties, cars, etc. in websites like Craigslist for sale or rent. The process overcomes several common challenges often faced by sellers, buyers, and intermediaries (websites).

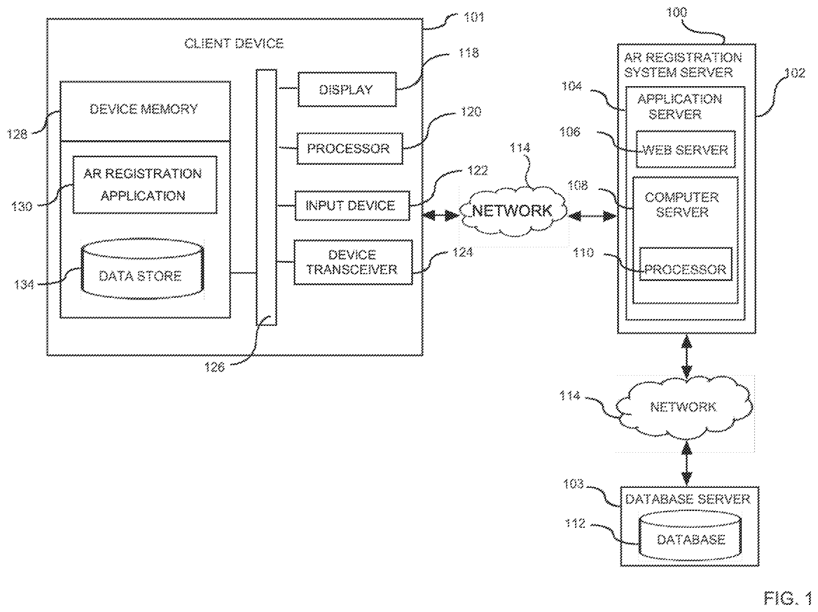

Referring now to FIG. 1, the general architecture of a client-server application system 100 that operates in accordance with exemplary embodiments to enable the improved bidding process described, is depicted. The system depicted in FIG. 1 is generalized in nature and is only an example of a system on which the improved bidding process may be carried out. In an exemplary embodiment, system 100 is implemented in multi-tier or n-tier architecture with one or more client devices 101 residing at the client tier, one or more servers 102 in the middle or server application tier and one or more database servers 103 residing in the database tier. In the above variant of three-tier architecture the client, the first tier, may have to only perform the user interface i.e., validate inputs; in which case the middle tier holds all the backend logic and does data processing while the data server, the third tier, performs data validation and controls the database access.

One or more client devices 101 are connected to system server 102 via a network 114. The system server 102 communicates with the client devices 101 over the network 114 to present a user interface or graphical user interface (GUI) for the service system 100 of the present invention. The user interface of the service system 100 of the present invention can be presented through a web browser or through a mobile application communicating with the system server 102 and is used for displaying, entering, publishing, and/or managing data required for the service. As used herein, the term “network” generally refers to any collection of distinct networks working together to appear as a single network to a user. The term also refers to the so-called world wide “network of networks” or Internet which is connected to each other using the Internet protocol (IP) and other similar protocols. As described herein, the exemplary public network 114 of FIG. 1 is for descriptive purposes only and it may be wired or wireless.

Although the description may refer to terms commonly used in describing public networks such as the Internet, the description and concepts equally apply to other public and private computer networks, including systems having architectures dissimilar to that shown in FIG. 1. The inventive idea of the present invention is applicable for all existing cellular network topologies or respective communication standards, such as GSM, UMTS/HSPA, LTE and the like.

With respect to the present description, the system server 102 may include any service that relies on a database system that is accessible over a network, in which various elements of hardware and software of the database system may be shared by one or more users of the system 100. To this end, the users of the client device 101, from which a request or instruction is received over a network 114, may include any individual customer, a governmental or non-governmental organization, a group etc. The GUI or user interface provided by the system server 102 on the client devices 101 through a web browser or mobile app may be utilized by the users for utilizing service system 100.

The components appearing in system server 102 refer to an exemplary combination of those components that would need to be assembled to create the infrastructure to provide the tools and services contemplated by the present invention. As will be apparent to one skilled in the relevant art(s), all of components “inside” of system server 102 may be connected and may communicate via a wide or local area network (WAN or LAN).

The system server 102 includes an application server or executing unit 104. The application server or executing unit 104 comprises a web server 106 and a computer server 108 that serves as the application layer of the present invention. The Web server 106 is a system that sends out Web pages containing electronic data files in response to Hypertext Transfer Protocol (HTTP) requests from remote browsers (i.e. browsers installed in the client devices 101) or in response to similar requests made through a mobile app or mobile application of the present invention installed on a client device 101. The web server 106 can communicate with the mobile app of the present invention and/or with a web browser installed on a client device 101 to provide the user interface required for the service.

The computer server 108 may include a processor 110, a random-access memory (RAM) (not shown in figures) for temporary storage of information, and a read only memory (ROM) (not shown in figures) for permanent storage of information. Computer server 108 may be generally controlled and coordinated by operating system software. The operating system controls allocation of system resources and performs tasks such as processing, scheduling, memory management, networking, and I/O services, among (other) things. Thus, the operating system resides in system memory and, on being executed by CPU, coordinates the operation of the other elements of AR server 102.

Although the description of the computer server 108 may refer to terms commonly used in describing computer servers, the description and concepts equally apply to other processing systems, including systems having architectures dissimilar to that shown in FIG. 1.

The database tier is the source of data where at least one database server 103 generally interfaces multiple databases 112. Those databases are frequently updated by their users and administrators most often through a combination of private and public networks 114 including the Internet. It would be obvious to any person skilled in the art that, although described herein as the data being stored in a single database, different separate databases can also store the various data and files of multiple users.

A mobile application, or “app,” is a computer program that may be downloaded and installed in client device 101 using methods known in the art. Hereinafter, the mobile app 130 is referred to as app 130. App 130, custom built for the present invention, enables one or more persons to do various tasks related to live, in-person translation services using the system of the present invention. The activities related to the service of the present invention can also be performed using the user interface (or GUI) presented through a client device-based web browser.

Hereinafter, the term “user interface” is used to refer to both app user interface and the web browser user interface of the present invention. Examples of client device 101 may include, but not limited to, mobile devices, tablets, hand-held or laptop devices, smart phones, personal digital assistants, desktop computers, wearable devices, augmented reality glasses, virtual reality headsets, or any similar device.

As illustrated in FIG. 1, the client device 101 may include various electronic components known in the art for this type of device. In this embodiment, the client device 101 may include a device display 118, a computer processor 120, a user input device 122 (e.g., touch screen, keyboard, microphone, and/or other form of input device known in the art), a device transceiver 124 for communication, a device memory 128, the AR app 130 operably installed in the computer memory 128, a local data store 134 also installed in the device memory 128, and a data bus 126 interconnecting the aforementioned components. For purposes of this application, the term “transceiver” is defined to include any form of transmitter and/or receiver known in the art, for cellular, WIFI, radio, and/or other form of wireless or wired communication known in the art. Obviously, these elements may vary, or may include alternatives known in the art, and such alternative embodiments should be considered within the scope of the claimed invention.

As stated earlier, traditional bidding systems and processes have a variety of shortcomings. For example, assume in a regular marketplace website (e.g., craigslist), a seller lists an item and then receives two negotiated offers from two potential buyers: A & B. If A's offer is more than B's, the seller would normally go with A. But what if B is willing to offer more but didn't know or believe the seller (in case he told him) about the other higher offer he received from A. This causes the seller to lose the best offer, and causes the buyer to lose a chance to offer more and win the deal.

Another common and major challenge particularly in regular online auctions is the problem of shill bidding. This is when sellers or their associates place bids on their own items to artificially increase price. Also, for intermediary websites, they often have a major issue with monetization. Charging for listing is not desirable and can drive away sellers (fees often nonrefundable even if the item doesn't sell); and some also face the issue of selling off site to avoid fees. Further, listings in regular online auction formats are often not effective or attractive as they often end with items unsold, in which case owners have to relist, and pay additional fees.

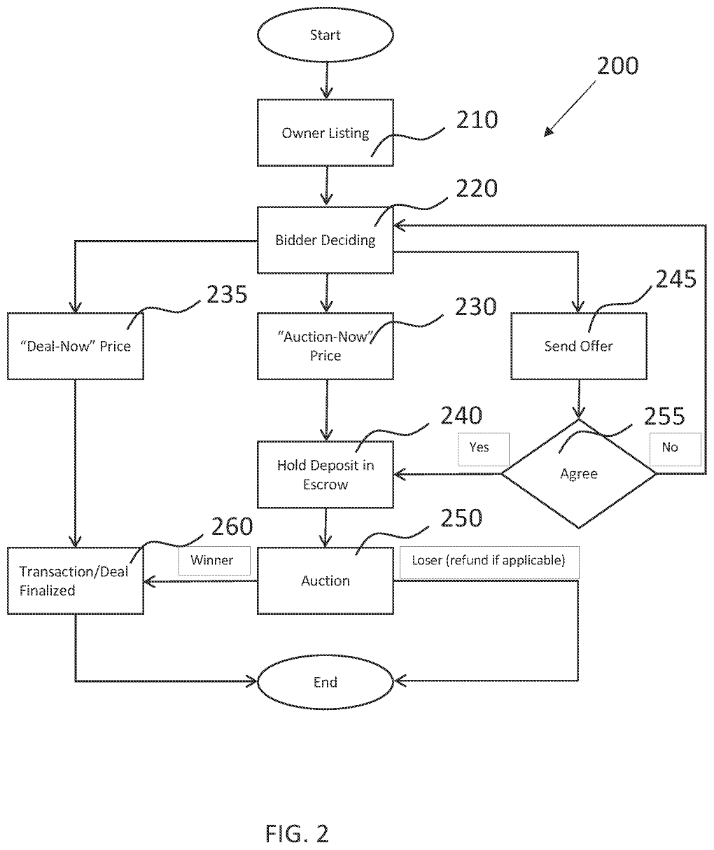

These challenges along with others are overcome by the improved bidding process depicted in FIG. 2.

Referring now to FIG. 2, an exemplary forward bidding process 200 is depicted. The improved bidding process of the present invention utilizes two phases:

[symbol]

Phase 1:

The improved bidding process starts off with a seller enlisting an item for sale (process 210). A potential buyer can have more than one option to complete the deal with (process 220). One embodiment of the improved bidding process is the option of Send Offer (process 245). In this option, the seller receives and exchanges various negotiated offers from potential buyers which can lead to an agreement with a buyer on a certain price (process 255). Following the agreement, the buyer would have his/her deposit held into an escrow account (process 240). The deposit can be a fixed amount or a percentage of the bid price. Next, the software implementing the bidding process on the system of FIG. 1 transitions to the phase 2 auction (process 250).

Phase 2:

In phase 2 (process 250), the software runs a regular, quick auction using the accepted offer of phase 1 as the opening bid. This provides a final chance to any other interested bidders who can afford and want to bid more money to win the deal. Bidders here cannot bid in the auction until they pay a deposit like the one made in phase 1. During the auction, bidders, including the bidder of the accepted offer in phase 1, bid against each other without the ability to retract a bid once it's placed.

At the end of the auction, the highest bidder is declared the winner, and then proceeds to finalize transaction with the seller and complete the deal (process 260). Failing to do that, the bidder would risks the deposit being forfeited. Losing bidders' deposits are refunded to them.

An alternative embodiment of the improved bidding process may include the use of “Auction-Now” Price (process 230). This option enables a seller to set a discounted price that takes the process to phase 2 directly, i.e., automatic acceptance.

Another aspect to be understood is that the pre-phase 2 deposit is arbitrary depending on the condition of the marketplace and participants degree of trustworthiness. It can be as low as 0% (waived) with cases when risk of fraud is minimal, for example private professional markets exclusively for licensed, registered participants in good standing.

Therefore, this improved bidding process will greatly benefit all three parties: sellers, buyers, and intermediaries in many ways. For example, sellers will ensure to receive the best offer from still-interested serious buyers by encouraging them for a last chance to outbid in a quick auction for an item it has already sold otherwise. This will make the auction attractive to other serious buyers, if any, who can afford more and want to benefit from this chance knowing the item has been sold anyway with apparently a discounted price. They also feel more comfortable in bidding with measures restricting shilling behaviors, such as requiring bidders to make verified deposits before bidding and the risk of losing it if retracted from completing the deal. These mutual benefits will motivate both sellers and buyers to employ this protected process through the intermediary (such as website) assuring they not be selling off site and thus help intermediary in monetization.

Directing attention to FIG. 2, another option (process 235) can be incorporated along with the improved bidding process to further enrich the experience of both the owner and the bidders. In this option, the owner provides bidders an incentive to avoid a possible competition by offering them to pay the optimum “Deal-Now” Price and taking a shortcut route to complete the transaction without going through the auction altogether.

This process can be utilized in both forward auction and reverse auction. The present invention also includes a reverse auction that is opposite to the (forward) auction described above. That is, in a reverse auction, buyers are those who put up the request for the good/service and receive offers, and sellers are those who place the offers and bid, and the one with the lowest offer among the approved sellers, will be the winner.

In accordance with exemplary embodiments, the owner/bidder may be able to set multiple (one or more) prices with different auction duration in which the prices and the auction duration are inversely proportional (in a forward auction) or may be able to set multiple prices and the auction duration are directly proportional (in a reverse auction).

Also, in accordance with exemplary embodiments, listings and/or bidding participants can be selected or pre-approved by owner, private or public etc. The word owner or bidder may refer to any of the person/entity itself, his/her/its representative, designated agents, etc.

When referred to herein the meaning of “auction” may include English auction, first-price sealed-bid auction, second-price sealed-bid auction (Vickrey auction), etc.

In accordance with exemplary embodiments, the method of payment for deposits and closing are arbitrary: e.g., credit/debit card, money transfer, demand draft, certified check, cash, bank guarantee, surety bond, cryptocurrency, etc.

In accordance with an exemplary embodiment and as stated earlier, the auction scheme detailed may be applied to reverse auctions as well as forward auctions. In either a forward or a reverse auction, the bid can be a calculated weighted average of the price offered by the bidder and the qualification score of the bidder by the owner. (e.g, the owner has approved two bidders X & Y, and he gives X a technical qualification score of 70/100, and Y score 90/100, if the owner put a weight of 60% on qualification and 40% on price, then if X bids $100, and Y bids $80, the resulting bid value of X would be =(70*0.6+100*0.4)=82, and bid value of Y=(90*0.6+80*0.4)=86, thus Y wins).

While an improved bidding process has been described in detailed, it is to be understood that numerous changes and modifications can be made to embodiments of the present invention without departing from the scope of the invention.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

What is claimed is:

1. A bidding process for selling or renting an item or service to a highest bidder, comprising:
receiving from an owner a listing for an item or service;
displaying the listing to potential bidders;
setting a price by the owner to the item for which a potential bidder can win the item pending an auction and for which prices are inversely proportional to auction durations;
receiving an acceptance indication from a bidder to a set price;
conducting an auction using the accepted set price as an opening bid among the potential bidders;
declaring a highest bidder as winner of the auction; and
instructing the owner and the winning bidder to finalize transaction and complete the deal.

2. The method of claim 1, further comprising:
receiving a deposited payment from at least one of the potential auction bidders;
refunding at least a portion of the deposits to bidders, other than the highest bidder, who have deposited a payment to support a potential bid; and
paying at least a portion of the payment received from the winning bidder to a party other than the owner and the winning bidder.

3. The method of claim 1, wherein:
the set price is received as an offer by a potential bidder to the owner or as an offer by the owner to a potential bidder; and
receiving an acceptance indication by the owner to the set price.

4. The method of claim 2, wherein:
the set price is received as an offer by a potential bidder to the owner or as an offer by the owner to a potential bidder; and
receiving an acceptance indication by the owner to the set price.

5. The method of claim 1, 2, 3 or 4, further comprising:
offering a higher Deal-Now price to the owner, which if accepted, would avoid the auction.

6. A bidding process for buying or renting an item or service to a lowest bidder, comprising:
receiving from an owner a listing for an item;
displaying the listing to potential bidders;
setting a price by the owner to the item for which a potential bidder can win the item pending an auction and for which prices are directly proportional to auction durations;
receiving an acceptance indication from a bidder to a set price;
conducting an auction using the accepted set price as an opening bid among the potential bidders;
declaring a lowest bidder as winner of the auction; and
instructing the owner and the winning bidder to finalize transaction and complete the deal.

7. The method of claim 6, further comprising:
receiving a deposited payment from at least one of the potential auction bidders;
refunding at least a portion of the deposits to bidders, other than the lowest bidder, who have deposited a payment to support a potential bid; and
paying at least a portion of the payment received from the winning bidder to a party other than the owner and the winning bidder, or receiving a deposited payment from the owner; and
paying at least a portion of the payment received from the owner to a party other than the owner and the winning bidder.

8. The method of claim 6, wherein:
The set price is received as an offer by a potential bidder to the owner or as an offer by the owner to a potential bidder; and
receiving an acceptance indication by the owner to the set price.

9. The method of claim 7, wherein:
The set price is received as an offer by a potential bidder to the owner or as an offer by the owner to a potential bidder; and
receiving an acceptance indication by the owner to the set price.

10. The method of claim 6, 7, 8 or 9, further comprising:
offering a lower Deal-Now price by the owner, which if accepted, would avoid the auction.

11. A computer-readable medium containing instructions which, when executed by a computing device connected to other computing devices on a telecommunication network, implement a bidding process for selling or renting an item or service to a highest bidder, comprising:
receiving from an owner a listing for an item or service;
displaying the listing to potential bidders;
setting a price by the owner to the item for which a potential bidder can win the item pending an auction and for which prices are inversely proportional to auction durations;
receiving an acceptance indication from a bidder to a set price;
conducting an auction using the accepted set price as an opening bid among the potential bidders;
declaring a highest bidder as winner of the auction; and
instructing the owner and the winning bidder to finalize transaction and complete the deal.

12. The computer-readable medium of claim 11, further comprising:
receiving a deposited payment from at least one of the potential auction bidders;
refunding at least a portion of the deposits to bidders, other than the highest bidder, who have deposited a payment to support a potential bid; and
paying at least a portion of the payment received from the winning bidder to a party other than the owner and the winning bidder.

13. The computer-readable medium of claim 11, wherein:
The set price is received as an offer by a potential bidder to the owner or as an offer by the owner to a potential bidder; and
receiving an acceptance indication by the owner to the set price.

14. The computer-readable medium of claim 12, wherein:
The set price is received as an offer by a potential bidder to the owner or as an offer by the owner to a potential bidder; and
receiving an acceptance indication by the owner to the set price.

15. The computer-readable medium of claim 11, 12, 13 or 14, further comprising:
offering a higher Deal-Now price by the owner, which if accepted, would avoid the auction.

16. A computer-readable medium containing instructions which, when executed by a computing device connected to other computing devices on a telecommunication network, implement a bidding process for buying or renting an item or service to a lowest bidder, comprising:
receiving from an owner a listing for an item;
displaying the listing to potential bidders;
setting a price by the owner to the item for which a potential bidder can win the item pending an auction and for which prices are directly proportional to auction durations;
receiving an acceptance indication from a bidder to the set price;
conducting an auction using the accepted set price as an opening bid among the potential bidders;
declaring a lowest bidder as winner of the auction; and
instructing the owner and the winning bidder to finalize transaction and complete the deal.

17. The computer-readable medium of claim 16, further comprising:
receiving a deposited payment from at least one of the potential auction bidders;
refunding at least a portion of the deposits to bidders, other than the lowest bidder, who have deposited a payment to support a potential bid; and
paying at least a portion of the payment received from the winning bidder to a party other than the owner and the winning bidder, or receiving a deposited payment from the owner; and
paying at least a portion of the payment received from the owner to a party other than the owner and the winning bidder.

18. The computer-readable medium of claim 16, wherein:
The set price is received as an offer by a potential bidder to the owner or as an offer by the owner to a potential bidder; and
receiving an acceptance indication by the owner to the set price.

19. The computer-readable medium of claim 17, wherein:
The set price is received as an offer by a potential bidder to the owner or as an offer by the owner to a potential bidder; and
receiving an acceptance indication by the owner to the set price.

20. The computer-readable medium of claim 16, 17, 18 or 19, further comprising:
offering a lower Deal-Now price by the owner, which if accepted, would avoid the auction.
